(19) United States
(12) Patent Application Publication
(10) Pub. No.: US 2005/0248719 A1
(43) Pub. Date: Nov. 10, 2005

(54) Event eyeglasses

(76) Inventors: Thomas A. Howell, Palo Alto, CA (US); David Chao, Saratoga, CA (US); C. Douglass Thomas, Campbell, CA (US); Peter P. Tong, Mountain View, CA (US)

Correspondence Address: IPVENTURE, INC., 5150 EL CAMINO REAL, SUITE A-22, LOS ALTOS, CA, 94022, US

(21) Appl. No.: 11/183,283

(22) Filed: Jul. 15, 2005

Related U.S. Application Data
(63) Continuation-in-part of application No. 10/964,011, filed on Oct. 12, 2004.
(60) Provisional application No. 60/509,631, filed on Oct. 9, 2003.
(60) Provisional application No. 60/527,565, filed on Dec. 8, 2003.
(60) Provisional application No. 60/562,798, filed on Apr. 15, 2004.
(60) Provisional application No. 60/583,169, filed on Jun. 26, 2004.
(60) Provisional application No. 60/592,045, filed on Jul. 28, 2004.
(60) Provisional application No. 60/605,191, filed on Aug. 28, 2004.
(60) Provisional application No. 60/592,045, filed on Jul. 28, 2004.
(60) Provisional application No. 60/605,191, filed on Aug. 28, 2004.
(60) Provisional application No. 60/618,107, filed on Oct. 12, 2004.
(60) Provisional application No. 60/620,238, filed on Oct. 18, 2004.
(60) Provisional application No. 60/647,836, filed on Jan. 31, 2005.
(60) Provisional application No. 60/647,826, filed on Jan. 31, 2005.

(51) Int. Cl. G02C 1/00

(52) U.S. Cl. 351/41

(57) ABSTRACT

A pair of glasses with first and second lens holders for receiving lenses, a bridge element that couples the lens holders, and a pair of temples. The temples are pivotally secured to the lens holders. In one embodiment, the glasses further include a speaker being powered by a power source. The pair of glasses can deliver information through the speaker to the person wearing the glasses. The information being delivered can be wirelessly transmitted to the glasses from a remote device. The information can be pre-recorded and available at the glasses, or the information can be wirelessly received by the glasses as it is produced. The information can be relevant to an event, and available for a relatively short duration of time. In another embodiment, a pair of glasses further includes an information input mechanism that allows the person to input information into the glasses. Such input information can be wirelessly transmitted from the glasses to a remote device.

### CROSS-REFERENCE TO RELATED APPLICATIONS

This application is a continuation-in-part of U.S. patent application Ser. No. 10/964,011, filed Oct. 12, 2004, and entitled “TETHERED ELECTRICAL COMPONENTS FOR EYEGLASSES,” which is hereby incorporated herein by reference, which in turn claims priority to each of: (i) U.S. Provisional Patent Application No. 60/509,631, filed Oct. 9, 2003, and entitled “TETHERED ELECTRICAL COMPONENTS FOR EYEGLASSES,” which is hereby incorporated herein by reference; (ii) U.S. Provisional Patent Application No. 60/527,565, filed Dec. 8, 2003, and entitled “ADAPTABLE COMMUNICATION TECHNIQUES FOR ELECTRONIC DEVICES,” which is hereby incorporated herein by reference; (iii) U.S. Provisional Patent Application No. 60/562,798, filed Apr. 15, 2004, entitled “EYEWEAR WITH ULTRAVIOLET DETECTION SYSTEM,” and which is hereby incorporated herein by reference; (iv) U.S. Provisional Patent Application No. 60/583,169, filed Jun. 26, 2004, entitled “ELECTRICAL COMPONENTS FOR USE WITH EYEWEAR, AND METHODS THEREFOR,” and which is hereby incorporated herein by reference; (v) U.S. Provisional Patent Application No. 60/592,045, filed Jul. 28, 2004, entitled “EYEGLASSES WITH A CLOCK OR OTHER ELECTRICAL COMPONENT,” and which is hereby incorporated herein by reference; and (vi) U.S. Provisional Patent Application No. 60/605,191, filed Aug. 28, 2004, entitled “ELECTRICAL COMPONENTS FOR USE WITH EYEWEAR, AND METHODS THEREFOR,” and which is hereby incorporated herein by reference.

The application also claims priority to each of: (i) U.S. Provisional Patent Application No. 60/592,045, filed Jul. 28, 2004, entitled “EYEGLASSES WITH A CLOCK OR OTHER ELECTRICAL COMPONENT,” and which is hereby incorporated herein by reference; (ii) U.S. Provisional Patent Application No. 60/605,191, filed Aug. 28, 2004, entitled “ELECTRICAL COMPONENTS FOR USE WITH EYEWEAR, AND METHODS THEREFOR,” and which is hereby incorporated herein by reference; (iii) U.S. Provisional Patent Application No. 60/618,107, filed Oct. 12, 2004, and entitled “TETHERED ELECTRICAL COMPONENTS FOR EYEGLASSES,” which is hereby incorporated herein by reference; (iv) U.S. Provisional Patent Application No. 60/620,238, filed Oct. 18, 2004, entitled “EYEGLASSES WITH HEARING ENHANCED AND OTHER AUDIO SIGNAL-GENERATING CAPABILITIES,” and which is hereby incorporated herein by reference; (v) U.S. Provisional Patent Application No. 60/647,836, filed Jan. 31, 2005, and entitled “EYEGLASSES WITH HEART RATE MONITOR,” which is hereby incorporated herein by reference; and (vi) U.S. Provisional Patent Application No. 60/647,826, filed Jan. 31, 2005, and entitled “EYEWEAR WITH ELECTRICAL COMPONENTS,” which is hereby incorporated herein by reference.

In addition, this application is related to each of: (i) U.S. patent application Ser. No. 10/822,218, filed Apr. 12, 2004, and entitled “EYEGLASSES FOR WIRELESS COMMUNICATIONS,” which is hereby incorporated herein by reference; (ii) U.S. patent application Ser. No. 10/964,011, filed Oct. 12, 2004, and entitled “TETHERED ELECTRICAL COMPONENTS FOR EYEGLASSES,” which is hereby incorporated herein by reference; (iii) U.S. patent application Ser. No. 11/006,343, filed Dec. 7, 2004, and entitled “ADAPTABLE COMMUNICATION TECHNIQUES FOR ELECTRONIC DEVICES,” which is hereby incorporated herein by reference; (iv) U.S. patent application Ser. No. 11/078,855, filed Mar. 11, 2005, and entitled “EYEWEAR WITH RADIATION DETECTION SYSTEM,” which is hereby incorporated herein by reference; (v) U.S. patent application Ser. No. 11/078,857, filed Mar. 11, 2005, and entitled “RADIATION MONITORING SYSTEM,” which is hereby incorporated herein by reference; (vi) U.S. patent application Ser. No. 11/______, filed concurrently herewith, and entitled “EYEWEAR SUPPORTING AFTER-MARKET ELECTRICAL COMPONENTS,” which is hereby incorporated herein by reference; (vii) U.S. patent application Ser. No. 11/______, filed concurrently herewith, and entitled “EYEGLASSES WITH HEARING ENHANCED AND OTHER AUDIO SIGNAL-GENERATING CAPABILITIES,” which is hereby incorporated herein by reference; (viii) U.S. patent application No. 11/______, filed concurrently herewith, and entitled “EYEGLASSES WITH ELECTRICAL COMPONENTS,” which is hereby incorporated herein by reference; (ix) U.S. patent application No. 11/______, filed concurrently herewith, and entitled “EYEGLASSES WITH A CLOCK OR OTHER ELECTRICAL COMPONENT,” which is hereby incorporated herein by reference; and (x) U.S. patent application No. 11/______, filed concurrently herewith, and entitled “EYEGLASSES WITH ACTIVITY MONITORING,” which is hereby incorporated herein by reference.

### FIELD OF THE INVENTION

The present invention relates to eyeglasses and, more particularly, to eyeglasses for events.

### BACKGROUND OF THE INVENTION

Many of us have been to events, such as to a baseball game. It would be fun to get information regarding the event, while attending it. For example, the information can be related to the teams playing at the game, their players and their statistics. If different teams are vying for a playoff spot at a different site, it would be interesting to know how the other teams are doing. Such information should be provided at the discretion of the users. You probably do not want to hear statistic concerning a player during a very intense moment of the game. If possible, you also probably do not want to hold onto a device that provides such information because, during the game, your hands should be free. One typically desires their hands to be available for different purposes, such as to make interesting gestures.

It is also not uncommon for the organization running or companies sponsoring the event to provide promotional products. These promotional products, e.g., posters, shirts, towels, balls, etc., typically are used to provide company information to customers. Corporations usually use them to advertise their products and to promote themselves. Sometimes, the products are specifically related to the event.

For example, companies like to give away pens at events. One reason is that we need to write and, as we write, we look at the pen. But, the pen only has so much space for a company to provide information. Also, the information printed on the pen is static and cannot be changed. It would be advantageous if more information could be provided.

Accordingly, there is a need for a device that can provide information to a user for an event. The information can be provided to the user hands-free. The information can be available for a relatively short duration of time, such as during the event.

### SUMMARY OF THE INVENTION

One embodiment of the invention includes a pair of glasses that can provide, in an audio manner, information to a user. The user does not have to hold onto the glasses to hear the information. In other words, the information is provided in a hands-free manner. The information can be pre-recorded. In another embodiment, the information is transmitted to and received by the glasses. This allows the information to be dynamic. Though not necessary, the information can be directly relevant to an event attended by the user. There can also be a user input mechanism at the glasses to allow the user to provide user input, including user feedback.

In one embodiment, the pair of glasses has first and second lens holders for receiving lenses. Each of the lens holders has a first side and a second side. The pair of glasses has a bridge element that couples the first side of the first lens holder to the second side of the second lens holder. The pair of glasses also includes a first temple and a second temple. The temples can also be known as arms. The first temple is pivotally secured to the second side of the first lens holder through a joint, while the second temple is pivotally secured to the first side of the second lens holder through another joint. The pair of glasses can also include a speaker, which is powered by a power source, and the speaker can be turned on and off.

In another embodiment, each of the temples has a tapered profile that is wider when it is closer to its corresponding joint. Each lens holder can also have a shield at least at one of its edges. In one embodiment, the shields are shaped to generally conform to the profile of the face of the wearer. The surface areas on the temples or the shields can be used for promotion. For example, advertisements can be located on these areas.

The pair of glasses can deliver information through a speaker at the glasses to the person wearing the glasses. The information can be related to an event. The event can be organized (or sponsored) by a company. For example, an event can be a sporting contest, a trade show, a tour, etc. In another embodiment, an event can be viewed from the perspective of the person attending it. For example, an event can be buying a product from a store. When the person is at the store, the person is at the event.

The information available can be for entertainment, or for promotion of a product or a company. The information can be in different languages depending on the preference of the person. The information can be available for a limited duration of time. This duration of time can be set by an event. When the event is over, there can be no more information available. The duration can also be set by the power source running the electrical components in the glasses. The power source can be designed such that it is not replaceable by the user, or replacing the power source typically would break at least a portion of the glasses. So, when the power source is drained, no more information will be available to the user.

In one embodiment, the speaker at a pair of glasses is part of a radio, and the information is wirelessly received by the radio. In another embodiment, the speaker is part of a player, with the information previously recorded and stored in a storage medium of the player. The previously recorded information can be stored in the glasses, or in a storage device attachable to the glasses.

In another embodiment, a pair of glasses includes an information input mechanism, which allows a user to provide inputs. The mechanism can be implemented by a switch at the glasses. The glasses can have a transceiver. The user inputs can be wirelessly transmitted to, for example, the company sponsoring the event that the user is attending. The company can use such glasses, for example, to obtain feedback from the audience of the event.

In one embodiment, the glasses can be given away, such as for promotional purposes. The glasses can also be rented out during an event. Such glasses can be tracked with bar codes or RFID tags.

In yet another embodiment, the glasses function as a headset, and are wired or wirelessly coupled to a portable device. The portable device can also be carried by the user of the glasses. The portable device can provide more areas for user inputs and outputs.

The invention can be implemented in numerous ways including, a method, system, device, apparatus, and a computer readable medium. Several embodiments of the invention are discussed below.

### BRIEF DESCRIPTION OF THE DRAWINGS

FIG. 1 shows one embodiment of the invention with a speaker in one of the temples of a pair of glasses.

FIG. 2 shows a number of attributes regarding a number of applications of glasses according to different embodiments of the invention.

FIG. 3 shows some electrical components of a player according to an embodiment of the invention.

FIG. 4 illustrates a number of forces activating a switch according to a number of embodiments of the invention.

FIG. 5 illustrates a number of mechanical forces activating a switch according to a number of embodiments of the invention.

FIG. 6 shows a Hall-effect detector at a joint of a pair of glasses according to an embodiment of the invention.

FIGS. 7A-7C illustrate different embodiments of a quadrature sensor according to the invention.

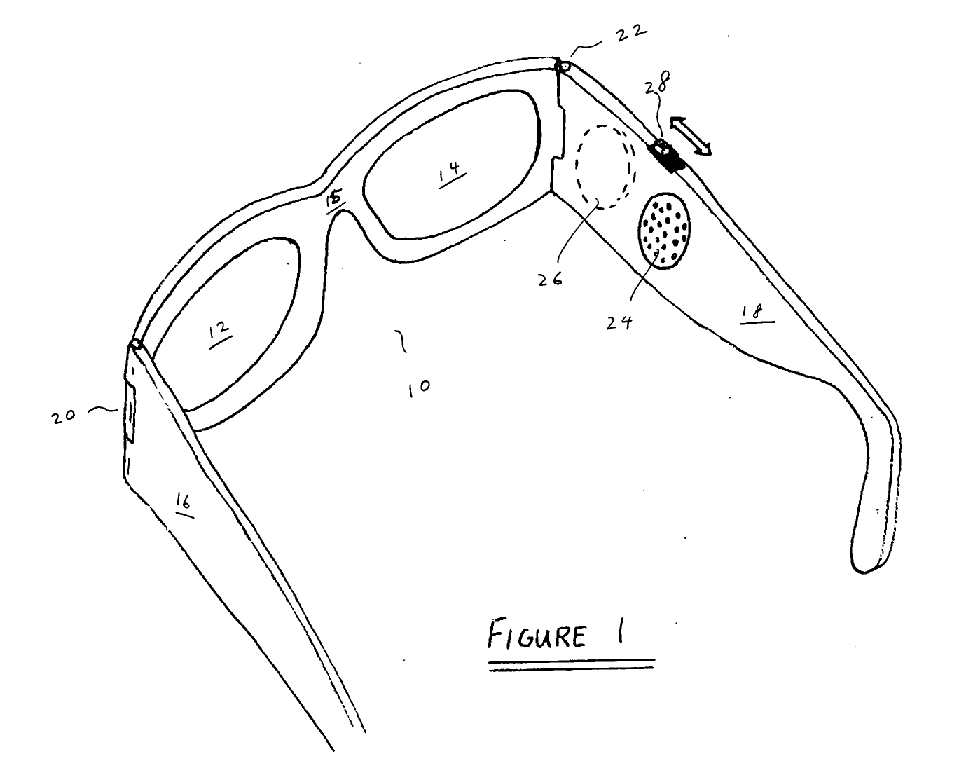

Same numerals in FIGS. 1-7C are assigned to similar elements in all the figures. Embodiments of the invention are discussed below with reference to FIGS. 1-7C. However, those skilled in the art will readily appreciate that the detailed description given herein with respect to these figures is for explanatory purposes as the invention extends beyond these limited embodiments.

### DETAILED DESCRIPTION OF THE INVENTION

FIG. 1 shows one embodiment of the present invention. The embodiment includes a pair of glasses 10 with a first lens holder 12 and a second lens holder 14. Both lens holders are for receiving lenses. The first lens holder 12 has a first side and a second side. The second lens holder 14 also has a first side and a second side. The pair of glasses has a bridge element 16. The bridge element is coupled to the first side of the first lens holder 12 and the second side of the second lens holder 14. In one embodiment, the lens holders and the bridge element are not separate pieces, but are an integral piece.

The pair of glasses 10 also includes a first temple 16 and a second temple 18. The first temple 16 is pivotally secured to the second side of the first lens holder 12 through a joint 20. And, the second temple 18 is pivotally secured to the first side of the second lens holder 14 through another joint 22. The glasses 10 further include a speaker 24, a power source 26 and a switch 28. The speaker 24 is powered by the power source 26, and the switch 28 is used to turn the speaker 24 on and off. The pair of glasses 10 can deliver information through the speaker 24 to the wearer or user of the glasses 10. In one embodiment, the information is available for a duration of time. With the speaker 24 close to at least one of ears of the wearer of the glasses 10, the information provided to the user can be provided in a relatively private manner.

In different embodiments, the glasses 10 can be a pair of sunglasses, fit-over glasses, prescription glasses or other types of glasses. In a number of embodiments, the frames of the glasses have more surface area than frames with minimal structure, such as those frames with lenses connected together by wires. For example, the temples of the glasses can have a tapered profile. Each of the temples is wider or broader when it is close to its corresponding joint. In one embodiment, the temple is wider or broader by spanning across a wider or broader area longitudinally downward, creating a bigger surface in an orientation generally parallel to the side of the user's head. FIG. 1 shows an example of such an embodiment.

In another embodiment, there can be a shield at least at one edge of each of the lens holders of the glasses. These shields can wrap around, or better conform to the profile of, the face of the wearer. The shields can be opaque. There can be transparent or translucent windows on these shields. To illustrate, in fit-over sunglasses, when worn over a pair of prescription glasses, such shields can go over or cover at least a portion of the pair of prescription glasses. Note that in one embodiment, a pair of glasses does not have to include lenses.

In one embodiment, a pair of glasses is for an event. An event can be viewed from the perspective of one or more organizations sponsoring or organizing the event. These events can be, for example, a basketball game, a concert, or a trade show. These events are provided or sponsored by one or more organizations or companies. In a number of embodiments where information is available from a speaker at a pair of glasses and the glasses are for an event, the information made available from the speaker is related to the event. In such embodiments, the information can be available for only a limited duration of time and the duration is associated with the event, which can include some time (such as buffer time) before the event and some time after the event. When the event is over, which can include any post-event buffer time, the information will generally not be available.

In another embodiment, an event can be viewed from the perspective of the person at the event. From the perspective of the person, an event can be buying a product from a store. This can be considered an event from the point of view of the person at the event. Typically, it has a beginning, it has an end, and there is a purpose or a theme. The information is available to the person when the person is at or proximate to a location associated with the event, such as a building. When the person is away from the location, the information will not be available.

In one embodiment, the duration of an event is not more than a week. In another embodiment, the duration is not more than a day. In yet another embodiment, the duration of an event is not more than a few hours, such as nine hours.

In one embodiment, there is advertising or promotional material on a pair of glasses, and the material is related to an event. The material can be on the surface area provided by temples, shields or other areas on a pair of glasses. For example, if the event is about dinosaurs in the Jurassic period provided by an organization, there can be a Brachiosaurus printed on the glasses. The organization can use the surface area on the glasses as places for advertisement of not only the event, but also the organization itself. The organization can also sell such surface area to other companies, which can provide additional promotional material on the glasses.

Referring back to FIG. 1, it shows one embodiment of the invention where there is a speaker 24 in one of the temples 18 of the glasses 10.

In one embodiment, the information is available for a duration of time, which can be short. For example, the power source 26, which can be a battery, may not have enough power to run the speaker 24 in its full capacity for a long duration. To illustrate, the battery 26 only has enough power to run the speaker continuously for a short duration of time, which can be less than a few hours with the speaker 24 at its highest volume possible, when it is turned on by the switch 28 in the glasses 10. The battery 26 can be encapsulated in the glasses 10, such as in one of the temples 18 of the glasses 10. The battery 26 can be a coin battery or a AAA battery, or other types of batteries. In one implementation, the glasses are designed such that the battery 26 is not easily replaceable by the user. The battery 26 can be inside a temple and the temple can be sealed so that the battery 26 is typically not replaceable without breaking the temple.

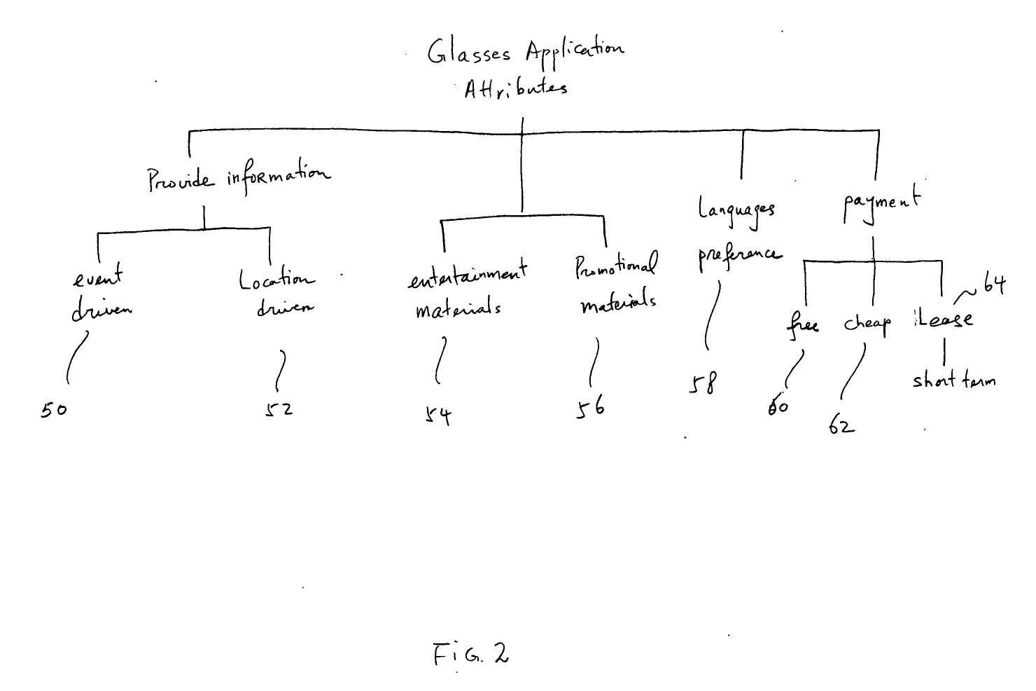

FIG. 2 shows a number of attributes regarding the applications of the glasses, such as the glasses shown in FIG. 1, according to different embodiments of the invention.

In one embodiment, the information provided by the glasses can be driven by an event organized by an organization 50. For example, the user is at a football game in a stadium. The information can be related to a star player, such as his statistics, or other interesting information regarding the team. The information can be for an event related to the event at the stadium. For example, the user is at the Stanford Stadium watching the game between the Stanford and the Berkeley football teams. However, periodic update information or other types of information, such as play-by-play information, from a game at the UCLA Stadium between UCLA and USC can be provided to the user. All four teams are vying for the PAC 10 title. The user at the Stanford Stadium, who might be an UCLA fan, can hear about how the UCLA team is performing, while watching the Stanford/Berkeley game.

In the embodiments where information is available from the glasses, the information is available hands-free, [without the need to obstruct the user's hearing???]. This allows the user to use both of his hands totally freely, for whatever other purposes the user prefers, including providing different gestures.

In the embodiments where information is available, such as through a radio, the information can be available almost instantaneously when the electrical components in the embodiments are activated or turned on. This can be important during high intensity games. If it takes 30 seconds to start the system before information is available, such down time may not be available or tolerable during the games.

The user in an event may not be the audience or the observer of the event. In one embodiment, the user using a pair of glasses in the present invention not only attends the event, the person also helps to produce the event. For example, the event is a game, and the person is a coach of one of the teams playing in the game. Additional embodiments will be described where a pair of glasses is coupled to a handheld device. The glasses provide information to the coach, who can use the handheld device for a number of purposes, such as to track plays or calls.

In one embodiment, the information available at a pair of glasses can be advertising materials available during the break time of a game. The advertising materials can, for example, be from a company organizing or sponsoring the event, or from one of the teams in the event.

As another example, the event is an indoor event, such as an indoor concert.

The information can be location driven 52, which in one embodiment can be considered as an event attended by a user when the user is at the location. For example, the user is in a store, with many products. The products can be services. As the user moves around the store, he looks at different products. In one approach, each product is designated by a number. By entering the specific number into the glasses or into a portable device coupled to the glasses, such as through a switch, information pertinent to the corresponding product will be available to the user. As another example, the user can be in an exhibit hall, a trade show or in a museum. As the user strolls in the hall, information of different exhibits is available to him. Or, the user can be walking around a botanical garden, and is given a virtual, unguided tour by the glasses of the different type of plants in the garden. When the user moves away from such locations, the information will not be available.

The user can be at places where he is alone, or he does not know anybody. He might be bored. For example, he can be in a dental office having his teeth cleaned. Or, he can be in a bank waiting for his turn. Different types of information can be available to him. For example, if the bank has a new home loan program, such information is available to him. Again, when the user moves away from such location, the information will not be available.

The information can be for entertaining 54 the user. Or, the information is primarily promotional 56 in nature. The promotion can be related to the event the user is participating, or the promotion can be related to the location, such as the company associated with the user's location.

The information can be in different languages 58. For example, glasses with a red dot provide information in English, while glasses with a white dot provide information in Spanish. Or, there can be a switch on the glasses that allows setting the language to that preferred by the user.

The glasses can be given away 60. They can be sold at a relatively low price 62. Or, the glasses can be for temporarily use, such as the user can borrow, rent or lease 64 the glasses for a short duration of time. To track such glasses after they have been rented, each pair of glasses can have an identifier, such as a bar code. The bar code can be located on the inside of the glasses, such as on the inside of a temple of the glasses. In another embodiment, each pair of glasses can also or alternatively have a RFID tag, which can be wirelessly tracked. The tag can be in a temple, such as in the vicinity of the tip of the temple, or its temple tip. A temple tip is, in general, in a region of the temple substantially furthest away from the hinge of that temple. The organization responsible for renting out the glasses can ask for the user's identity card, which can be the user's driver's license. The card is then linked to the bar code, the RFID tag or other identifier of the glasses. When the user returns the glasses, the user can reclaim the corresponding identity card.

Referring back to FIG. 1, the embodiment 10 includes a speaker 24 that is at least partially embedded into the glasses. There are different approaches to embed an electrical component, such as a speaker, into different types of glasses. A number of approaches are described, for example, in the various related patent application noted above.

In one embodiment, the pair of glasses 10 shown in FIG. 1 includes a radio, and the speaker is a part of the radio. All the electronics for the radio are at least partially embedded in the glasses. For example, the electronics can be on a printed circuit board, and the board is in one of the temples of the glasses. Information is provided to the user through the radio. The radio can be an AM or a FM receiver. In one embodiment, the receiver is pretuned to the frequencies of the transmitter of the information. Or, before the glasses are distributed, the radio is set to receive signals from a specific frequency band. Also the radio may not include an external tuner or switch on the glasses for the user to tune the radio to listen to another frequency band. In another embodiment, the receiver is tunable by a switch on the glasses to one or more frequencies.

The information can be information captured by a microphone or other pickup device, and transmitted over radio frequency waves to the radio.

As to the transmitted frequencies, typically government agencies, such as the FCC in the United States, regulate the availability of frequency ranges, particularly when the power of transmission is not low. In one embodiment, the transmitted frequencies can be on either side of the standard FM radio bands. They can be within the television VHF frequency range of 50 megahertz to 150 megahertz, or 49 to 88 MHz, or 108 to 220 MHz. Selecting such frequencies can have the advantage of having receiver components more readily available and less expensive. But, the frequencies selected may vary depending on costs, performance and/or FCC or other government agency requirements.

In another embodiment, the transmitted frequencies are in the CB (Citizen Band) radio band.

In yet another embodiment, the transmitted frequencies are FM-sidebands. This would allow the use of FM sideband receivers. Using such sidebands typically would require a lease from radio stations.

In one embodiment, information is transmitted to the glasses through a Wi-Fi network, or a WiMax network.

Also, the frequencies transmitted could be based on spread spectrum techniques. In other words, though the frequencies would constantly change, the transmitter and the receiver would be synchronized following the changing frequencies. In a number of countries, such embodiments do not require government license.

Information can typically reside within a few MHz. In one embodiment, the radio in the glasses is a narrow-band receiver, with a bandwidth of 3-6 MHz.

In yet another embodiment, the radio can receive signals from one of multiple and proximate AM modulated frequencies. For example, in a museum, information from adjacent artwork can be transmitted based on frequencies centered at the different frequencies. The radio receiver is a broader band AM receiver, which can be a receiver non-tunable by the user. Depending on proximity, the radio will adjust automatically to capture the frequency of the carrier for information regarding the particular artwork and excludes cross-talks from information regarding its immediate adjacent artworks.

Another embodiment considers the power level of the transmitted signals. If the power level of the transmitted signals is low, signals do not travel an excessive distance beyond the transmitter of the signals. For example, the low power level can be between ¼ to ½ watts. Or, the low power level is not more than 50 milliwatts. If the transmitted power level is low, it is relatively easier to meet government agencies, such as the FCC's, guidelines. Cost and complexity of the circuitry are usually also reduced. High power transmission typically requires special government approval.

In one embodiment, the transmission path between the transmitter and the receiver is primarily line of sight, and the information can be transmitted via, for example, infrared.

In yet another embodiment, there can be multiple transmitters. This can then keep transmission power low even if a large or unusually shaped area is to be covered. The corresponding radio will capture its signals from the transmitters based on proximity.

In one embodiment, the frequency of the radio cannot be tuned at the glasses by the user. The frequencies are fixed upon distribution of the glasses. In another embodiment, the frequencies of interest can be changed. For example, there can be an EPROM in the glasses that can be programmed. Or, one can replace a chip in the glasses to adjust the frequencies. In yet another embodiment, there can be one or more switches at the glasses to change the frequencies.

A number of embodiments have been described where the glasses include a radio to receive broadcast information. In another embodiment, the information to be received is previously programmed or recorded within a memory device. The glasses include a player to play the information stored in the memory device, and the player includes a speaker. The player is at least partially embedded in the glasses. In one embodiment, the glasses can include the memory device with the recorded information.

The memory can be on a printed-circuit board and, for example, can store up to 256 MB. The memory can be a built-in or removable flash memory. In one embodiment, the glasses include one or more connectors. The memory embedded in the glasses can be coupled to a device external to the glasses through the one or more connectors. As an example, a 256 MB flash memory is in one of the temples of a pair of glasses, and there is a USB connector at, for example, the end of that temple (close to the ear) to couple to an external device or instrument.

With the storage medium embedded, the glasses can upload information in the memory to or download information into the memory from an external device, such as a computer. A user can couple the glasses into the computer through a connector, either directly or indirectly. For example, indirect coupling might use an intermediate wire between the computer and the glasses.

In yet another embodiment, the memory device is external to the glasses. The memory device is coupled to the glasses through a connector at the glasses. If such removable memories are deployed for an event, the memories can be rented out during the event. Again, such memories can be tracked based on, for example, identifiers stored in the memories, or attached to the memories.

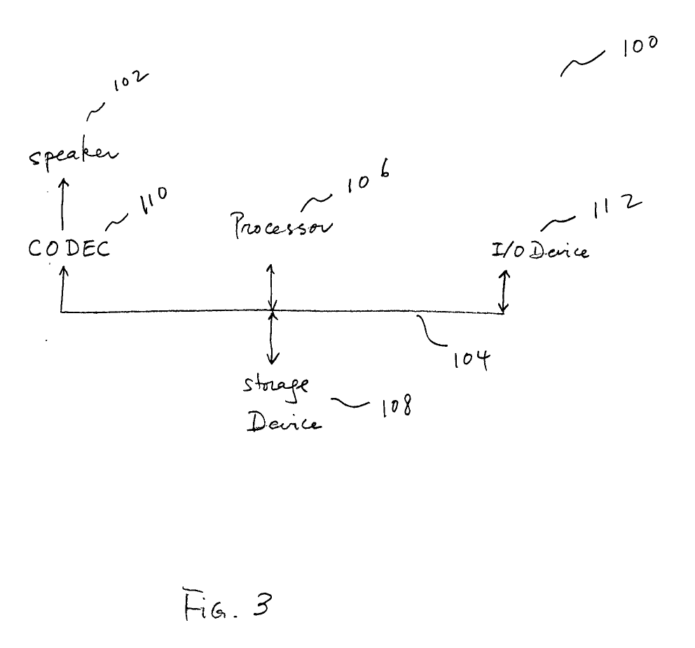

FIG. 3 shows some of the electrical components for a player 100 in a glasses according to an embodiment of the invention. The player includes a speaker 102, a data bus 104 to facilitate data transfer among, for example, a processor 106, a storage device 108, and a coder/decoder (CODEC) 110. The processor 106, which can be a microprocessor or controller, controls the operation of the player 100. The storage device 108 stores the information, which can be different types of appropriately-formatted media data. In one example, the information is digitally encoded audio signals. The storage device 108 can include a number of separate storage elements. For example, the device can be a flash memory device, or a minidisk device, and a cache, which can improve the access time and reduce power consumption of the storage device 108. The storage device 108 typically also includes a Read-Only Memory (ROM), which stores programs, utilities or processes to be executed in a non-volatile manner. The player 100 can also include a RAM, such as for the cache.

Once a piece of information is selected to be played, the processor 106 would supply the piece of information to the CODEC 110, which decompresses the media data and produces analog output signals for the speaker 102. In one embodiment, the bus 104 is also coupled to an input/output device 112, which would allow information to be downloaded from an instrument to the glasses.

There are different approaches to identify a piece of information to be played. In one embodiment, different pieces of information in the storage device 108 can be categorized, and the categorization can be hierarchical, with multiple levels in the hierarchy. To illustrate, assume that there are three levels. The top level can be the name of the football team; the second level can be the names of the players on the team, and the third level can be scoring statistics or other attributes of the players. The entries, such as the name of the players, can be abbreviated. There can be a control knob or switch to allow the user to scroll down entries in a level. By pushing the knob, the user selects an entry, which can lead the user to the next level. There can be an entry for moving up a level also. In one embodiment, once an entry is selected, the identity of that entry will be announced. For example, a selected entry is about the statistics of Joe Smith. Once that entry is selected, the speaker will state, “Joe Smith statistics.” If that is the one the user wants, the user can signal his preference by, for example, pushing a switch.

In another embodiment, the information can be searched. The search can be based on one or more key words. As an example, the information is related to songs. A user can search by the name of the song, the name of the artists or music genre. Entry for the search term can be through voice recognition applications in the glasses. Based on the term verbalized by the user, a song will be selected. The glasses can ask the user if that is the song the user has selected. If the response is positive, the song will be played. If not, the glasses will ask the user to verbalize the term again. In another embodiment, entering the search terms is through the key pad of a portable device, wired or wirelessly, coupled to the glasses. Additional descriptions regarding having a portable device linked to a pair of glasses will be further discussed below.

With the speaker relatively close to at least one ear of the user, the volume of the speaker does not have to be very high. In one embodiment, the volume of the speaker is limited, such as the maximum sound level is not more than 60 dB. If the glasses are powered by a battery, limiting the volume of the speaker would extend the lifetime of the battery. Such a limit can also reduce the chance of the speaker generating audio signals that might disturb people in the vicinity of the user. This, in turn, helps to provide information to the user in a relatively private manner.

In one embodiment, the glasses are powered by a battery. To extend its lifetime, the glasses include a timer. For example, if the glasses have a radio, after the radio is turned on for a preset amount of time, the timer will turn the radio off automatically. In another embodiment, the glasses include a speaker and the timer would turn the speaker off after the speaker has been turned on for a preset amount of time. The preset time can be determined by the timer.

In another embodiment, the glasses are powered by other types of sources, such as a solar cell or a fuel cell. Such other type of sources can be at one of temples of the glasses.

As explained, in a number of embodiments, the glasses include a switch, which typically is at least partially embedded in the glasses. For example, the switch can be used to turn the speaker on, or to tune the frequency of a radio. If the glasses have two speakers, such as one on each of the temples, there can be two switches, one on each temple to control the corresponding speaker. The two speakers can be for generating stereo audio signals for the user. There can also be one control switch for both speakers.

The switch in the glasses can have different attributes. It can be activated by different type of forces, including mechanical, radiation, magnetic, electrical, and temperature. The switch can also be activated remotely by a remote device. The switch can be based on one or more detectors. The switch can have different degrees or ranges of control, such as binary, multiple discrete steps or incremental control. The switch can be placed at different position on the glasses, such as on the side or top surface of a temple or at a joint. The control can take perception into consideration, such as based on texture, height and lateral position of multiple switches.

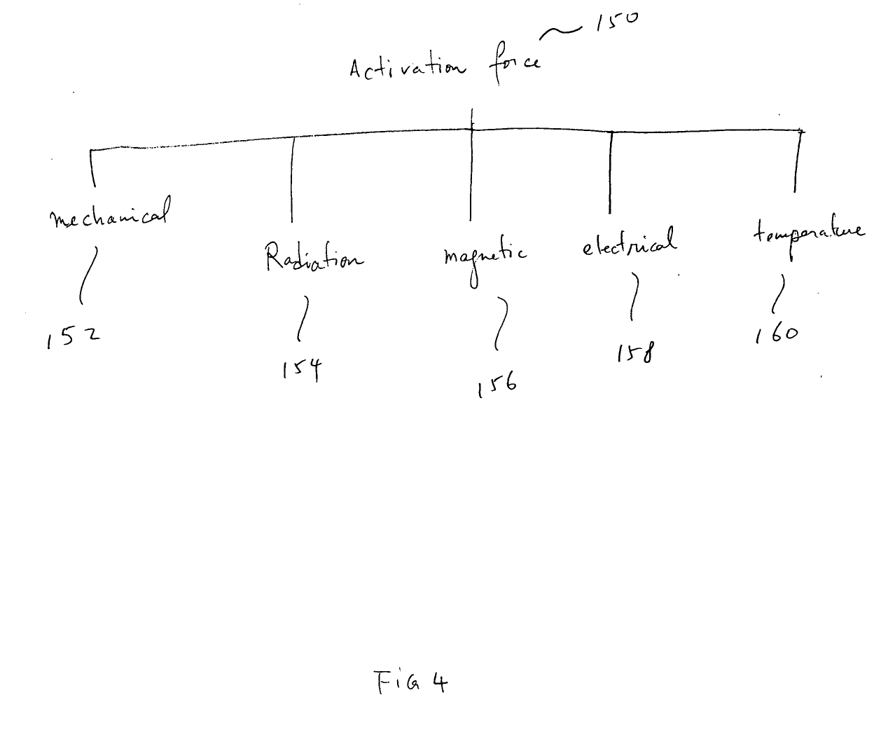

FIG. 4 illustrates a number of forces 150 activating the switch according to different embodiments of the invention. They can be based on, for example, mechanical 152, radiation 154, magnetic 156, electrical 158, and temperature 160.

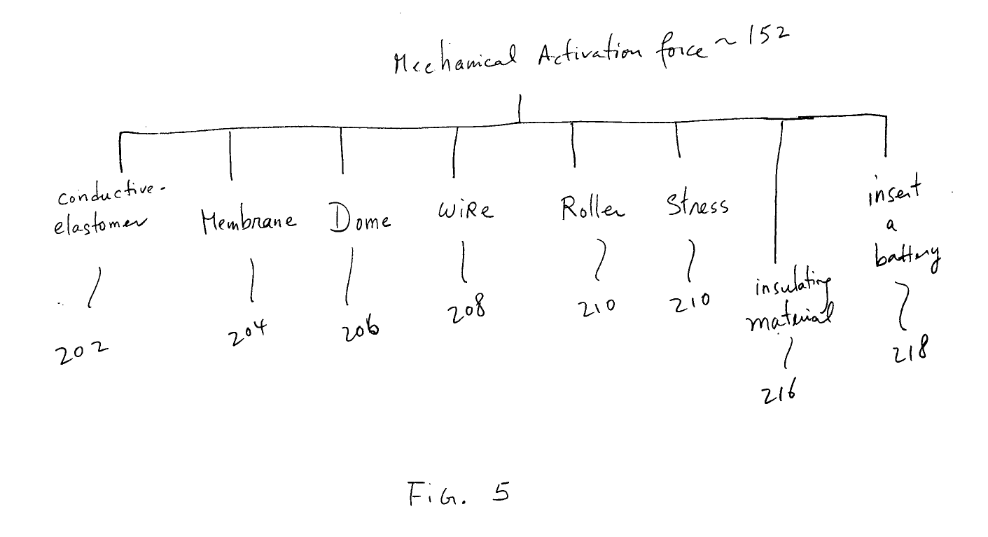

FIG. 5 illustrates a number of mechanical forces 152 activating the switch according to different embodiments of the invention. The mechanical switch or sensor can be a conductive-elastomer switch 202, a membrane switch 204, a dome switch 206, a relatively simple wire switch 208, and a roller switch 210, such as a switch including a wheel. Another type of mechanical force can be based on stress 210, such as a switch based on piezoelectric force or a piezoelectric device.

In yet another embodiment, the mechanical switch is made so that the electrical circuitry in the glasses can be activated but not deactivated by the user. In other words, once activated, the switch is designed not to be deactivated by the user, and the circuit will remain on till the power source inside the glasses is depleted. One approach to implement such a switch is based on a piece of insulating material 216 between a terminal of, for example, a battery and its contact with the circuit embedded in the glasses. When the battery is installed, at least one of its terminals is separated from its circuit contact. There can be a thin, flexible, insulating material, 216, such as a ribbon, positioned between the terminal and the contact. Though the circuit is embedded in the glasses, the insulating material 216 extends outwardly from inside the glasses through a hole, such as a small hole, in the side wall of, for example, a temple of the glasses. In one embodiment, the hole or slot is located above or below the terminal and the contact, or the hole is not directly inline with the terminal and the contact. By pulling the insulating material out from the glasses, the terminal will establish electrical connection with the contact, activating the circuit and turning the speaker on.

In another embodiment of a switch based on mechanical force 154, the mechanical force is the force that is used to insert 218 a battery into the glasses. Once the battery is inserted, the speaker in the glasses will be activated. The speaker will remain on until the battery is removed, or until the power in the battery is drained.

The switch can also be activated by radiation 154, or energies in a type of radiation, according to a number of embodiments of the invention. The radiation 154 can be in the optical, or infrared or ultraviolet range. For example, the switch includes a photodiode or photo sensor in the glasses, and there is an opening above the photodiode. In one embodiment, the diode is activated by light getting to the diode through the opening. In another embodiment, the circuit is activated if the opening is covered to prevent light from getting to the diode.

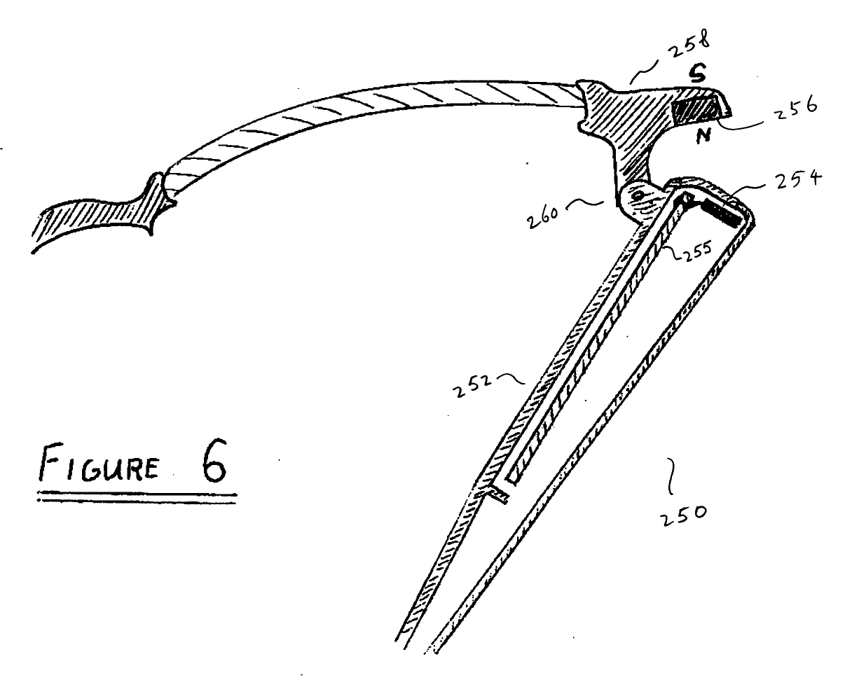

The switch can be activated by magnetic forces 156. For example, there can be a magnetic sensor or a Hall effect detector inside a temple proximate to a joint of a pair of glasses. FIG. 6 shows a section of a pair of glasses 250 with such a detector 254. The detector 254 is electrically connected to a printed circuit board 255. When the temple 252 is in its extended position, as when the glasses 250 are ready to be worn, the detector 254 will be directly adjacent to a magnet 256 inside a lens holder 258 at the corresponding joint 260. The magnet 256 would activate the Hall effect detector 254. In another embodiment, a magnetic switch is activated based on changing the inductance of a coil. For example, the switch includes a steel rod that can be positioned in or out of a coil. The switch's range of control is based on the position of the rod with respect to the coil.

The switch can be activated depending on electrical forces 158. In one embodiment, the electrical force depends on capacitive effect. By changing the capacitance, the switch is turned on and off. For example, the capacitance is changed by placing one's finger over a metallic pad. In another example, by changing the amount of overlap between two metallic sheets that are not in contact, the capacitance between the two metallic sheets will change. This then changes the range of control of the switch.

In another embodiment, the electrical force 158 is based on resistive effect. For example, the switch is made up of a slide or a rotary potentiometer. By changing the amount of coupling, the amount of resistance is changed to reflect the range of control of the switch.

In one embodiment, the switch's activation can depend on temperature 160. For example, the switch includes a temperature sensor. When the temperature reaches a certain point, the switch is activated.

In yet another embodiment, the switch is controlled by a remote controller. For example, the glasses include an infrared detector. The remote controller can generate infrared radiation. By aiming the controller at the detector, the infrared radiation can activate the infrared detector and the switch is activated. Or, if the user moves into the vicinity of a corresponding infrared transmitter, circuits in the glasses would be activated.

The switch can include one or more previously-described sensor or detector of different types of forces. For example, the switch can use two photo sensors. One sensor is exposed to light on the outside surface of the temple and the other is exposed to light on the inside surface of the temple, such as close to the ear. Based on their differential output, the switch is activated. As another example, there are two temperature sensors in the glasses. One is located close to a joint and the other is at the temple close to the ear. Again, the switching action depends on their differential outputs. In yet another embodiment, the glasses include more than one type of switch. There can be one type of switch, such as a mechanical switch, acting as an on/off switch, and another, such as a switch using electrical forces, as an incremental switch to change frequency.

As described, in a number of embodiments, the switch can provide different degrees or ranges of control. In one embodiment, there are two degrees of control, such as in an on/off switch. In another embodiment, there can be multiple discrete degrees, steps or positions. For example, the switch is a roller with discrete notches to indicate different discrete positions. Or, there can be two mechanical switches, placed side-by-side. Pushing one switch will increment one step, and pushing the other will decrement one step.

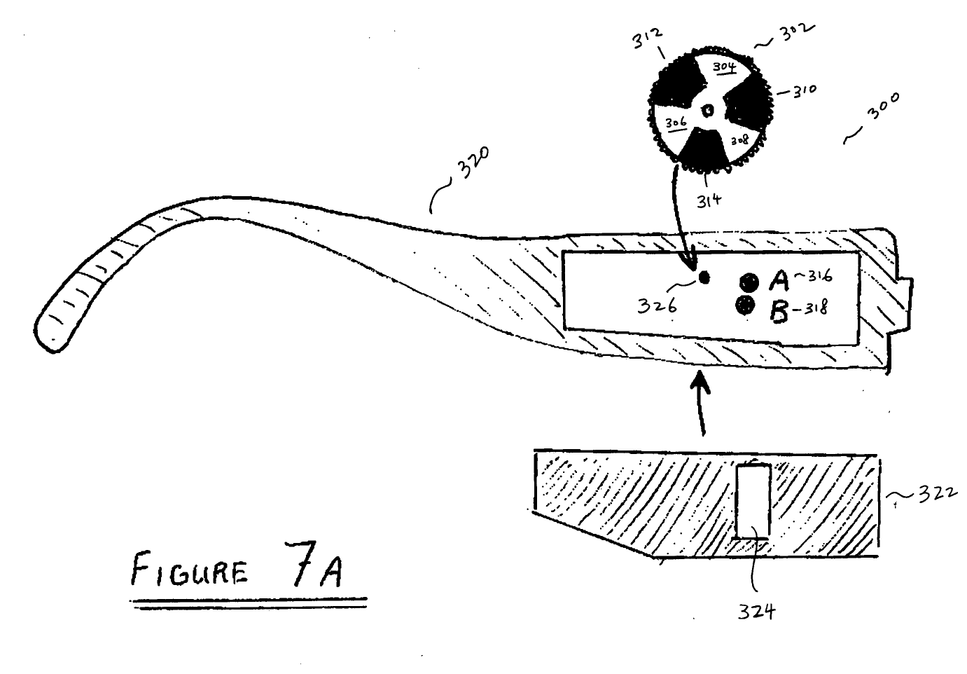

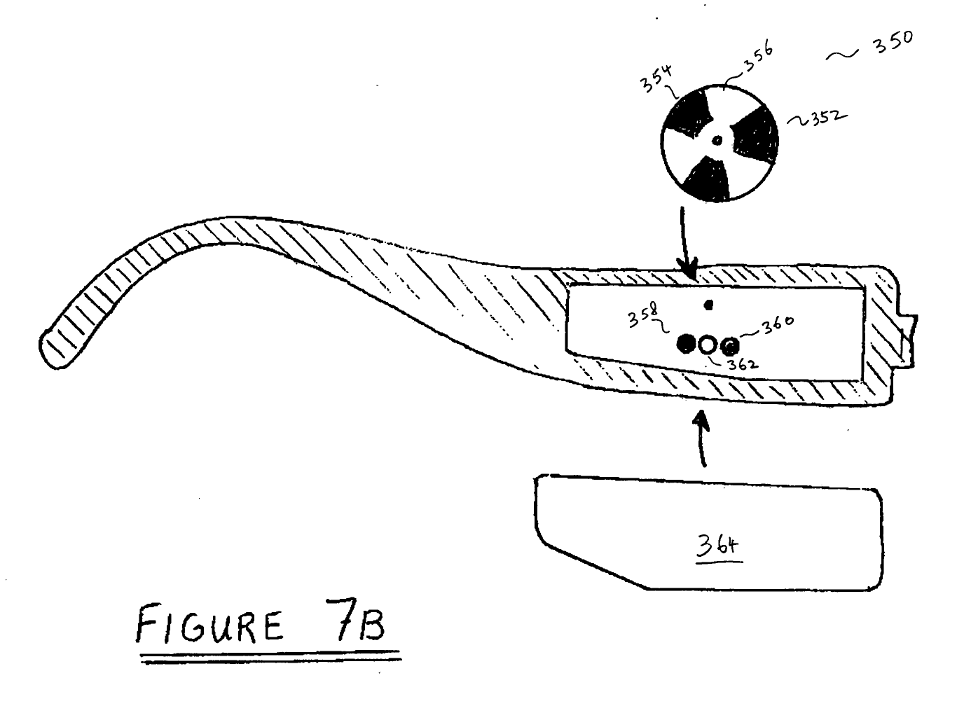

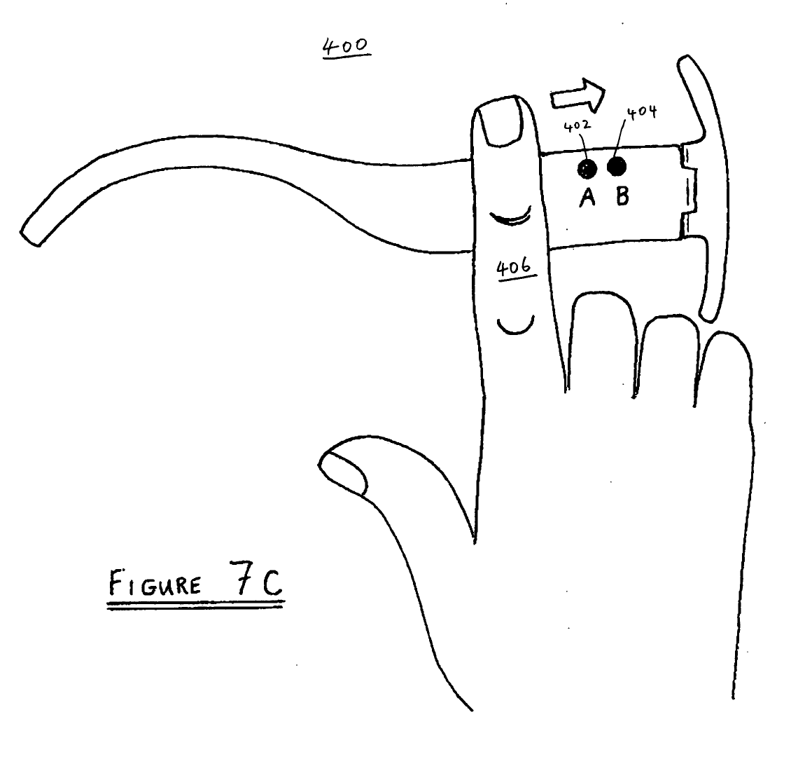

In yet another embodiment, the change from one degree to the next is gradual and not noticeably discrete. This can be achieved with 2 sensors arranged in quadrature. FIGS. 7A-7C show examples of different embodiments of such a switch based on two photodiodes or photo detectors.

FIG. 7A shows an embodiment 300 with a wheel 302 (roller) having clear strips, 304, 306 and 308, alternating with black strips, 310, 312 and 314, and two photodiodes, 316 and 318. Most of the wheel 302 and the two diodes, after incorporated into the temple 320, are covered by a piece of material 322. The two diodes, 316 and 318, are exposed to ambient light through a clear window 324. A part of the wheel 302 is extended out of the temple 320, allowing the wheel 302 to be turned about its axis 326. The wheel 302 can have teeth for friction turning. As the wheel 302 rotates about the axis 326, based on the differential outputs from the diodes, the direction of movement of the wheel 302—clockwise or counterclockwise—is determined. For example, if the wheel 302 is rotated clockwise, the top diode 316 senses light before the bottom 318 senses light. On the other hand, if the wheel 302 is rotated counterclockwise, the bottom diode 318 senses light before the top 316. Based on the signals from the two diodes, one would be able to tell if the wheel is being turned clockwise or counterclockwise. Clockwise can denote increase and counterclockwise can denote decrease. This embodiment can be used, for example, to change frequency. By turning the wheel 302 clockwise, the frequency of the radio goes up. And, by turning the wheel 302 counter-clockwise, the frequency goes down. Such a wheel 302 is also applicable for other purposes, such as controlling the volume of a speaker.

FIG. 7B shows an embodiment 350 with a wheel 352 having black 354 and reflecting 356 strips, two photodiodes, 358 and 360, and a LED 362. Again, most of the wheel, the two diodes and the LED are covered by a sheet of material 364. If a reflecting strip 356, instead of a black strip 354, goes over a diode, more light from the LED will be reflected back and received by the diode. If a black strip 354 goes over a diode, output from the diode will be significantly reduced. Again based on the signals from the diodes, the direction of rotation can be determined, which, in turn, can be used to indicate incrementing or decrementing outputs.

FIG. 7C shows an embodiment 400 again using two photodiodes, 402 and 404, but without a wheel. The two diodes, 402 and 404, are exposed to ambient light unless they are covered. In this embodiment, whether the finger 406 or another object is moving from the first diode 402 to the second diode 404, or from the second diode 404 to the first diode 402 can be determined based on the signals from the diodes. For example, the finger 406 sliding in a forward direction would trigger a signal from the first diode 402 before the second diode 404. On the other hand, sliding the finger in a backward direction would trigger a signal from the second diode before the first diode. Thus, the outputs from the two diodes can show the direction of movement of the finger. One can then, for example, assign forward movement (from the first 402 to the second 404) as increment, and backward movement (from the second 402 to the first 402) as decrement.

A switch can be placed at different location on a pair of glasses. In one embodiment, the switch is positioned on one of the side surfaces of one of the temples, such as the side that is not facing the face of the user when the glasses are worn. In another embodiment, the switch is positioned on a top surface of one of the temples. The switch 28 shown in FIG. 1 falls under this category. In yet another embodiment, the switch is positioned at one of the joints or hinges of the glasses. For example, there is a mechanical switch at a joint. If the corresponding temple is extended, as in the position when the glasses are worn, the switch will be pressed, which can indicate that the switch has been activated.

In one embodiment, the user can be using a switch when the glasses are worn. Depending on the position and the type of switch, the user may not be able to see the switch when he is manipulating it. In one embodiment, the design of the switch takes into consideration perception. To illustrate, there are two mechanical switches on the glasses. The top surfaces of the two switches have different texture. One switch has a smooth surface and the other has a rough surface. Pushing the rough surface implies incrementing one step and pushing the smooth surface implies decrementing one step. This type of perception design is based on tactile effect. In another example, the heights of the two switches are different. The taller switch is for one effect and the shorter is for another. In yet another embodiment, the lateral position of the two switches has significance. For example, the two mechanical switches are on the top surface or edge of a temple. By pushing the switch closer to the lens holder, the volume of the speaker in the glasses goes up; and by pushing the switch further away from the lens holder, the volume of the speaker goes down. In another example, the two switches are under the two ends of a piece of materials, such as a rocker-lever, which can be plastic. Rocking the plastic piece forward is an increment motion, and rocking the plastic piece backwards is a decrement motion.

A number of embodiments have been described where information is available only for a relatively short duration of time. In one embodiment, the information is available for a longer duration of time. For example, after the short duration of time, the battery in the glasses is drained. In order to continue on running the electronics inside the glasses to get the information, the user can replace the battery in the glasses with a new battery. In this embodiment, the glasses are designed so that the battery is replaceable by the user. Or, in another embodiment, the battery is rechargeable through a connector at the glasses.

A number of embodiments have been described regarding the glasses with a speaker for providing information to the user. In one embodiment, the glasses also include one or more light emitting diodes. The LEDs can be for entertaining purposes. For example, the information provided to the user is music. If the audio signals received are beyond a certain threshold, one or more of the LEDs will be activated. The activation of the one or more LEDs can then be synchronized to the sound of the speaker. In another example, a number of LEDs could be arranged as an array on the outside surface of one of the temples. The array could display graphics, pictures, or scrolling text. The array could also be located at other locations on the glasses, such as across the front surface or the top surface of the bridge or the lens-holders of the glasses.

One embodiment of the glasses includes a specially-designed surface texture, such as on the outside surface of a temple of the glasses. By scratching the surface texture, depending on its design, one can generate specific audio tones.

A number of embodiments have been described regarding electrical components in a temple of a pair of glasses. All of the electronic components can be self-contained inside the temple of the glasses. The components can be coupled to a printed circuit board. In other embodiments, some of the components are embedded fully or partially in other areas of the glasses, such as the lens holders or the bridge of the glasses. Or, one or more electrical components can be in a shield of the glasses.

A number of embodiments have been described regarding information available for a pair of glasses. In one embodiment, a pair of glasses also includes an information input mechanism that allows its user to input information into the glasses. Such information allows the user to provide inputs or feedbacks.

The information input mechanism can be implemented by a switch at the glasses, such as one of the switches previously described. The user input can be stored in the glasses if the glasses include memory storage electrical components. The input can be wirelessly transmitted from the glasses to a remote device if the glasses include wireless transceiver electrical components. For example, the user is at a football game, and the referee has made a controversial call. A broadcaster at the event can instantaneously use such glasses to perform a simple polling. This can be done by the broadcaster as part of the wireless transmission of information (e.g., event information) to the wearer of the glasses. Alternatively, the broadcaster can transmit a message to the user. In one embodiment, there can be an indicator on the glasses to indicate that there is a message for the wearer of the glasses. The indicator can be a LED light flashing for a few seconds, a ringing tone that rings for a few seconds, or other types of indication at the glasses. In any case, if desired, the wearer can receive the message. The message asks the wearer to push a button (an information input mechanism) at the glasses one time, if the wearer believes the call was correct, and two times otherwise. Such input information from the glasses is then wirelessly transmitted from the glasses and received by the broadcaster. Statistics on the responses can then be automatically performed. Such statistics can be provided almost instantaneously to, for example, the referee.

In one embodiment, each pair of such glasses also includes an identifier that identifies the glasses, such as an identification number. When input information is transmitted from such a pair of glasses, such as back to the broadcaster, its identifier can also be transmitted together with the corresponding input information.

Organizers of an event or a company affiliated with or related to the event also can use the glasses to gather other information from the wearers of the glasses, such as the audience of the event. For example, the audience can be electronically polled regarding ways to improve on the services they received.

The information input mechanism can include a microphone at the glasses. The organizers again can send a message to a user of a pair of such glasses. The message can be as follows: “If you like the ways we take food orders, say yes. If not, say no.” The voice response from the user is transmitted to the organizers. Such simple yes/no responses can be automatically deciphered based on voice recognition mechanisms and then automatically tabulated for the organizers.

In one embodiment, not all of the electrical components in a number of the glasses previously described are in the glasses. Instead, at least one of the electrical components, such as its power source, is in a portable device, which can also be carried by the user of the glasses. In another embodiment, a pair of glasses can function as a headset and are wired or wirelessly coupled to a portable device. The portable device can provide additional areas for user input, or outputs to the user.

As an example of wireless coupling for a pair of glasses functioning as a headset, the glasses include a wireless transceiver that is based on, for example, Bluetooth, UWB, Zigbee, or other types of short-distance wireless transmission standards. Based on the transceiver, the glasses are wirelessly coupled to a corresponding portable device. Information from long distances can be received by the portable device, which can then re-transmit such information to the glasses.

As an example of wired coupling for a pair of glasses functioning as a headset, the glasses include a connector. The connector can be used to electrically connect to a portable device through, for example, a wire. In one embodiment, the connector at the glasses is a male connector and is located at the tip of one temple of the glasses, such as at the tip position 19 of the second temple 18, shown in FIG. 1. When the male connector is not inserted into a female connector, the male connector can be covered, such as with a cap or a cover, to protect, encapsulate or shroud the connector. In one embodiment, at least a portion of the connector is covered.

Different embodiments of glasses functioning as a headset have been described in copending patent application, entitled, “EYEGLASSES WITH HEARING ENHANCED AND OTHER AUDIO SIGNAL-GENERATING CAPABILITIES”, which was incorporated by reference above, and can be used with the various embodiments described herein.

A number of embodiments have been described regarding glasses with a number of structural elements. In one embodiment, the glasses can be rimless frames. The glasses can include two lenses held together by a bridge. A temple can be attached to each lens through a joint that is connected to the corresponding lens by one or more screws. For example, there can be two screws at each lens to hold onto a temple piece, which includes a joint for a corresponding temple. One or more electrical components can be fully or partially embedded in the glasses, such as in a temple of the glasses.

A number of embodiments have been described with glasses. In one embodiment, a device, which is not a pair of glasses, can provide information to a user, where the information can be directly relevant to an event attended by the user. There can also be a user input mechanism at the device to allow the user to provide user input, including user feedback. Different embodiments of electrical components previously described can be in the device. Advantageously, in one embodiment, the different embodiments of components have minimal impact on the design of the end product and no tedious wiring is required. For example, in the case in which the end product is an eyeglass frame, a temple of the eyeglass frame can have an opening, cavity or container to hold or encompass the different embodiments of components, whereby no other changes or complications to the eyeglass frames need be imposed. Other such end-products can include: hats, shoes, watches, tee-shirt, swimming-suit, key-ring, purse, beer can holder, and other consumer products.

The various embodiments, implementations and features of the invention noted above can be combined in various ways or used separately. Those skilled in the art will understand from the description that the invention can be equally applied to or used in other various different settings with respect to various combinations, embodiments, implementations or features provided in the description herein.

A number of embodiments in the invention can be implemented in software, hardware or a combination of hardware and software. A number of embodiments of the invention can also be embodied as computer readable code on a computer readable medium. The computer readable medium is any data storage device that can store data which can thereafter be read by a computer system. Examples of the computer readable medium include read-only memory, random-access memory, CD-ROMs, magnetic tape, optical data storage devices, and carrier waves. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

Also, in this specification, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A pair of glasses comprising:
a first lens holder for receiving lenses, the first lens holder having a first side and a second side;
a second lens holder for receiving lenses, the second lens holder having a first side and a second side;
a bridge element coupling the first side of the first lens holder to the second side of the second lens holder;
a first temple pivotally secured to the second side of the first lens holder through a first joint;
a second temple pivotally secured to the first side of the second lens holder through a second joint; and
a speaker at least partially embedded in the glasses, with the speaker powered by a power source;
wherein the pair of glasses can deliver information through the speaker to the person wearing the glasses, and
wherein the information delivered is related to an event attended by the person.

2. A pair of glasses as recited in claim 1, wherein the event is organized by a company.

3. A pair of glasses as recited in claim 2, wherein the information is on another event that is related to the event attended by the person, which allows the person to physically attend one event while hearing information regarding the another event.

4. A pair of glasses as recited in claim 2, wherein the person helps to produce the event.

5. A pair of glasses as recited in claim 2, wherein the information pertains to advertising material from the company.

6. A pair of glasses as recited in claim 1,
wherein the person is at a location, and
wherein the information delivered is available when the person is at or proximate to the location.

7. A pair of glasses as recited in claim 1,
wherein the person is inside a store, which has a plurality of products, and
wherein the information delivered is related to at least one of the products.

8. A pair of glasses as recited in claim 1,
wherein there are promotional materials on the glasses, and
wherein the promotional materials are related to the event.

9. A pair of glasses as recited in claim 1, wherein the information can be in a plurality of languages.

10. A pair of glasses as recited in claim 1, wherein the glasses include an identifier for tracking the glasses.

11. A pair of glasses as recited in claim 10, wherein the glasses include a RFID tag for tracking the glasses.

12. A pair of glasses as recited in claim 1, wherein the speaker is part of a radio, which is at least partially embedded in the pair of glasses.

13. A pair of glasses as recited in claim 1, wherein the speaker is part of a player that can play the information stored in a memory device.

14. A pair of glasses as recited in claim 13, wherein the glasses include a connector, which can couple to the memory device that is external to the glasses.

15. A pair of glasses as recited in claim 1,
wherein the power source is a battery,
wherein the battery is encapsulated in a temple of the glasses, such that the battery is not designed to be replaced without breaking the temple.

16. A pair of glasses as recited in claim 1 further comprising an information input mechanism that allows the person to input information.

17. A pair of glasses as recited in claim 16,
wherein a company related to the event can send a message to the person, who can use the information input mechanism to respond to the message, and
wherein the message and the response are wirelessly received and transmitted respectively.

18. A pair of glasses as recited in claim 17 wherein the message is related to a polling performed by the company.

19. A pair of glasses as recited in claim 17,
wherein the glasses include an identifier that identifies the glasses, and
wherein the identifier is transmitted together with the response.

20. A pair of glasses as recited in claim 1 further comprising a wireless transceiver to wirelessly couple to a portable device carried by the person.

21. A pair of glasses as recited in claim 1 further comprising a connector to electrically connect to a portable device carried by the person.

22. A pair of glasses as recited in claim 21
wherein the connector is a male connector,
wherein the connector is located at a tip of the first temple, and
wherein the connector is covered when the connector is not connected to a female connector.
